(19) United States
(12) Patent Application Publication
(10) Pub. No.: US 2025/0193814 A1
(43) Pub. Date: Jun. 12, 2025

(54) TIME SYNCHRONIZATION AREA IN WIRELESS COMMUNICATION

(71) Applicant: ZTE CORPORATION, Shenzhen, Guangdong (CN)

(72) Inventors: Zhendong LI, Shenzhen, Guangdong (CN); Jinguo ZHU, Shenzhen, Guangdong (CN)

(21) Appl. No.: 18/848,110

(22) PCT Filed: Mar. 29, 2022
(86) PCT No.: PCT/CN2022/083539

§ 371 Date: Sep. 17, 2024

(51) Int. Cl. H04W 56/00; H04J 3/06; H04W 64/00

(52) U.S. Cl. CPC H04W 56/0015; H04J 3/0667; H04W 64/00

(57) ABSTRACT

Time synchronization between a network and user equipment (UE) and be more efficient by considering the time synchronization area of the UE. The time synchronization a where the UE can receive on demand time synchronization. When the time synchronization area is communicated, such as through a notification or indication, a time synchronization signal can be sent only when the UE is in the area. A time synchronization indication may be used during a handover process or while the UE is between idle and connect mode.

### TECHNICAL FIELD

This document is directed generally to wireless communications. More specifically, time synchronization is provided for devices on a network.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, improvements should be made to maintain and ensure the quality of service standards.

### SUMMARY

This document relates to methods, systems, and devices for time synchronization between a network and user equipment (UE). There may be a time synchronization area in which the UE can receive on demand time synchronization. The time synchronization area is communicated, such as through a notification or indication, so that a time synchronization signal is sent when the UE is in the area. A time synchronization indication may be used during a handover process of while the UE is between idle and connect mode.

In one embodiment, a method for wireless communication includes receiving a time synchronization area that covers a location for a user equipment (UE), and providing, based on the time synchronization area and the UE, a time to the UE for synchronization. The time synchronization area comprises a cell list, a tracking area (TA), or a TA list. The location comprises a service area in which the UE can receive a time synchronization signal, wherein the time synchronization signal is not provided to the UE when the UE is outside of the service area. A time sensitive control function receives information on whether the location is in the service area. The time sensitive control function comprises a Time Sensitive Communication Time Synchronization Function (TSCTSF) or a Time Sensitive Networking Adaptation Function (TSN AF). The TSCTSF or TSN AF enables a Precision Time Protocol (PTP) port in a Device Side Time Sensitive Networking (TSN) Translator (DS-TT) when the location is in the service area and disables the PTP port in the DS-TT when the location is outside the service area. The UE is identified for the location by a UE identification or a UE address. The receiving and the providing are by a base station, wherein an Access and Mobility Function (AME) provides the time synchronization area to the base station. The method includes determining when the UE is in the time synchronization area, and providing, only when the UE is in the time synchronization area, a time to the UE for time synchronization for the UE. The receiving is by AME, and the AMF receives the time synchronization area that covers a location for a user equipment (UE), and the method further includes sending an indication of whether time synchronization is provided to the UE from base station.

In another embodiment, a method for wireless communication includes providing a time synchronization area, and receiving a notification of whether a user equipment (UE) is within the time synchronization area. The UE receives a time synchronization signal when within the time synchronization area. The time synchronization area comprises a cell list, a tracking area (TA), or a TA list. The time synchronization area comprises a service area in which the UE can receive the time synchronization signal, wherein the time synchronization signal is not provided to the UE when the UE is outside of the service area. The providing is from a Time Sensitive Communication Time Synchronization Function (TSCTSF) or a Time Sensitive Networking Adaptation Function (TSN AF) to a base station. The TSCTSF or the TSN AF enables a Precision Time Protocol (PTP) port in a Device Side Time Sensitive Networking (TSN) Translator (DS-TT) when the location is in the service area and disables the PTP port in the DS-TT when the UE location is outside the service area. The UE is identified for the time synchronization area by a UE identification or a UE address. The providing is to a base station, wherein the method further includes determining, by a base station, when the identified UE is in the time synchronization area, and providing, from the base station to the UE, the time synchronization signal, wherein the time synchronization signal is only provided when the UE is in the time synchronization area.

In another embodiment, a method for wireless communication includes receiving a handover request that includes a time synchronization request indication, or receiving, during a handover in response to a path switch, a time synchronization request indication. The receiving the handover request or the receiving the time synchronization request indication is by a target base station from a source base station. The handover is a user equipment (UE) going from the source base station to the target base station. The target base station provides a time to the UE based on the time synchronization request indication. The method further includes receiving a time synchronization area, and limiting the time synchronization request based on the time synchronization area.

In another embodiment, a method for wireless communication includes receiving a subscription for a time synchronization area for a user equipment (UE), and sending a notification of whether the UE is inside or outside of the time synchronization area. The sending is from an Access and Mobility Function (AMF) to a Time Sensitive Communication Time Synchronization Function (TSCTSF) or a Time Sensitive Networking Adaptation Function (TSN AF). The sending is from a SMF to Time Sensitive Communication Time Synchronization Function (TSCTSF) or a Time Sensitive Networking Adaptation Function (TSN AF). The receiving is from a Time Sensitive Communication Time Synchronization Function (TSCTSF) or a Time Sensitive Networking Adaptation Function (TSN AF). The method further includes sending, to a base station, the notification of whether the DE is in the time synchronization area, and receiving, from the base station, the notification whether the UE is in or outside of the time synchronization area.

In another embodiment, a wireless communications apparatus comprising a processor and a memory, wherein the processor is configured to read code from the memory and implement any of the methods for wireless communication described herein.

In another embodiment, a computer program product comprising a computer-readable program medium code stored thereupon, the code, when executed by a processor, causing the processor to implement any of the methods for wireless communication described herein.

In another embodiment, system for wireless communication includes a Time Sensitive Communication Time Synchronization Function (TSCTSF) for providing a time synchronization area, and a base station communicating with the TSCTSF to receive the time synchronization area, wherein the base station provides a time synchronization signal to a user equipment (UE) when the UE is within the time synchronization area. The time synchronization area comprises a cell list a tracking area (TA), or a TA list. The time synchronization area comprises a service area in which the UE can receive the time synchronization signal, wherein the time synchronization signal is not provided by the base station to the DE when the UE is outside of the service area. The TSCTSF enables a Precision Time Protocol (PTP) port in a Device Side Time Sensitive Networking (TSN) Translator (DS-TT) when the UE is inside of the service area and disables the PTP port in the DS-TT when the UE is outside of the service area. The UE is identified for the time synchronization area by a UE identification or a UE address.

### BRIEF DESCRIPTION OF DRAWINGS

FIG. 1 shows an example base station.

FIG. 2 shows an example random access (RA) messaging environment.

FIG. 3 shows an embodiment of a wireless network system architecture.

FIG. 4 shows an embodiment of a wireless network system for time synchronization.

FIG. 5 shows an embodiment of time synchronization with access stratum time distribution on demand.

FIG. 6 shows an embodiment of time synchronization with Precision Time Protocol (PTP).

FIG. 7 shows an embodiment for providing a time synchronization area.

FIG. 8 shows an embodiment of access stratum (AS) time provisioning with an area restriction.

FIG. 9 shows another embodiment of access stratum (AS) time provisioning with an area restriction controlled by Access and Mobility Management Function (AMF).

FIG. 10 shows an embodiment of time synchronization with Precision Time Protocol (PTP) and with an area restriction.

FIG. 11 shows an embodiment of access stratum (AS) time synchronization during a handover.

FIG. 12 shows another embodiment of access stratum (AS) time synchronization during a handover.

FIG. 13 shows an embodiment of access stratum (AS) time synchronization while user equipment (UE) is in idle to connect mode.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an” or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the base station at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The base station or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

New Radio Access (“NR”) includes the ability to have time synchronization. Time synchronization between a network and user equipment (UE) and be more efficient by considering the time synchronization area of the UE. The time synchronization area is where the UE can receive on demand time synchronization. When the time synchronization area is communicated, such as through a notification or indication, a time synchronization signal can be sent only when the UE is in the area. A time synchronization indication may be used during a handover

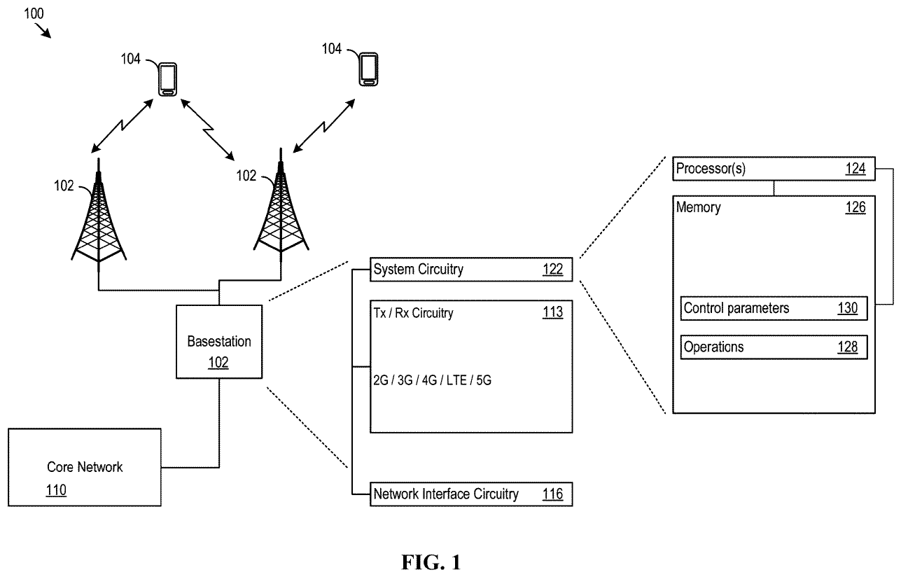

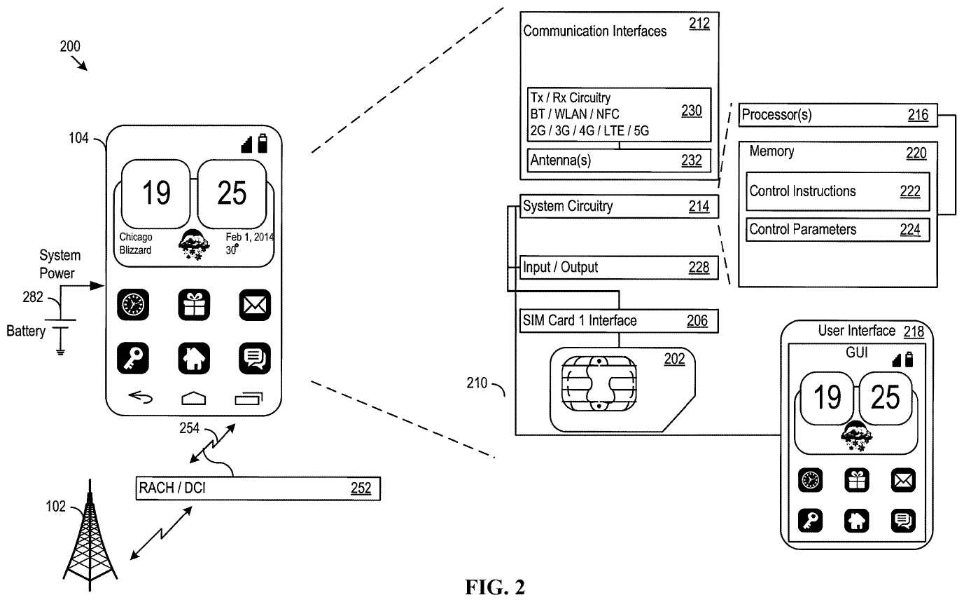

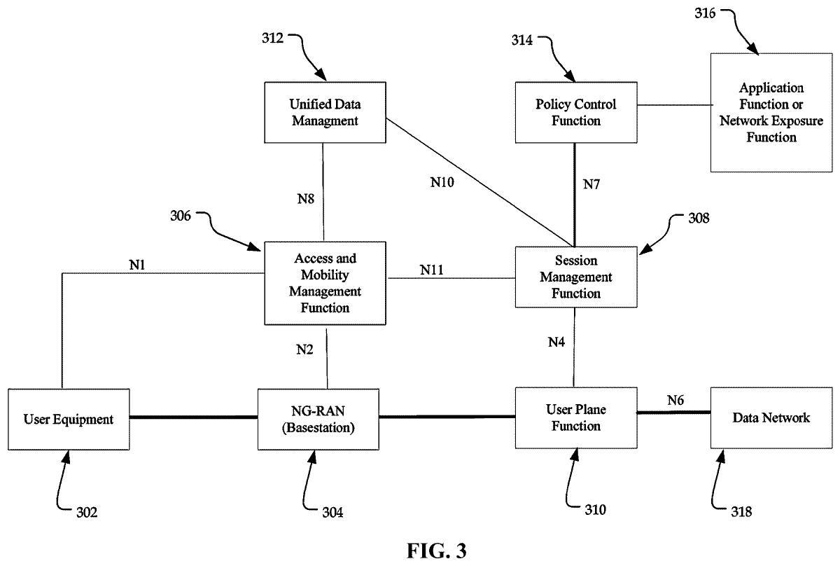

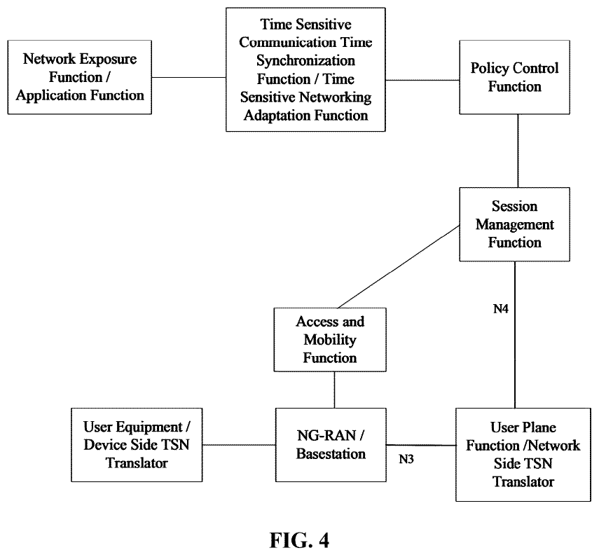

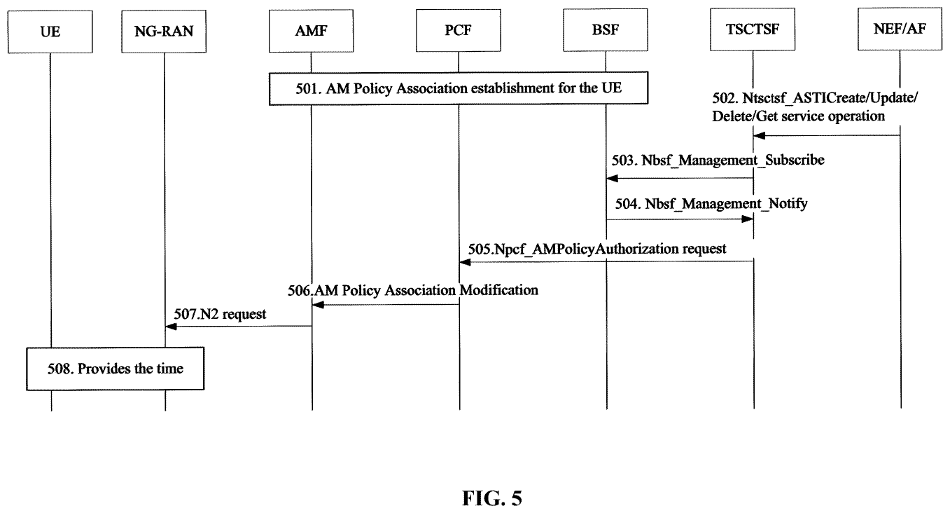

There may be different ways to provide a time synchronization service to devices (e.g. user equipment). The time synchronization signal may be referred to as access stratum time distribution. Access stratum time distribution may be deployed from a pre-configured Radio Access Network (RAN) nodes. The user equipment (UE) in an area may receive the precision time information when within the RAN coverage. When UE leave the area, the time synchronization signal may be area limited and no longer have access. The embodiments described below allow for a transmission of the time synchronization area for more efficient time synchronization distribution. In addition, UE's that have mobility (e.g. handover) can also have time synchronization. The RAN may be a part of a wireless communication system that connects UE devices to other parts of a network through radio or wireless connections. FIG. 1 illustrates an example NG-RAN or base station. FIG. 2 illustrates an example random access messaging environment. FIGS. 3-4 illustrate an example architecture for the time synchronization signaling. FIGS. 5-13 illustrate wireless communication examples for improved time synchronization.

FIG. 1 shows an example base station 102. The base station 102 may also be referred to as a wireless network node or a next generation radio access network (“NG-RAN”) node. The base station 102 may be further identified to as a nodeB (NB, e.g., an eNB or gNB) in a mobile telecommunications context. The example base station may include radio Tx/Rx circuitry 113 to receive and transmit with user equipment (UEs) 104. The base station may also include network interface circuitry 116 to couple the base station to the core network 110, e.g., optical or wireline interconnects. Ethernet, and/or other data transmission mediums/protocols.

The base station may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the base station. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

FIG. 2 shows an example random access messaging environment 200. In the random access messaging environment a UE 104 may communicate with a base station 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks. Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Ten Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

FIG. 3 shows one embodiment of a wireless network system architecture. This architecture is merely one example and there may be more or fewer components for implementing the embodiments described herein. The interconnections or communications between components are identified as N1, N2, N4, N6, N7, N8, N10, and N11, which may be referred to in the description or by other Figures. FIG. 2 illustrated an example user equipment (“UE”) 104, UE 302 is a device accessing a wireless network (e.g. 5GS) and obtaining service via a NG-RAN node or base station 304. The UE 302 interacts with an Access and Mobility Control Function (“AMF”) 306 of the core network via NAS signaling. FIG. 1 illustrates an example base station or NG-RAN 102. The NG-RAN node 304 is responsible for the air interface resource scheduling and air interface connection management of the network to which the UE accesses. The AMF 306 includes the following functionalities: Registration management, Connection management, Reachability management and Mobility Management. The AMP 306 also perform the access authentication and access authorization. The AMF 306 is the NAS security termination and relay the session management NAS between the UE 302 and the SMF 308, etc.

The SMF 308 includes the following functionalities: Session Management e.g. Session establishment, modify and release, UE IP address allocation & management (including optional Authorization). Selection and control of uplink function, downlink data notification, etc. The user plane function (“UPF”) 310 includes the following functionalities: Anchor point for Intra-/Inter-RAT mobility, Packet routing & forwarding, Traffic usage reporting, QoS handling for user plane, downlink packet buffering and downlink data notification triggering, etc. The Unified Data Management (“UDM”) 312 manages the subscription profile for the UEs. The subscription includes the data used for mobility management (e.g. restricted area), session management (e.g. QoS profile). The subscription data also includes slice selection parameters, which are used for AMF 306 to select a proper SMF 308. The AMF 306 and SMF 308 get the subscription from the UDM 312. The subscription data may be stored in a Unified Data Repository with the UDM 312, which uses such data upon reception of request from AMF 306 or SMF 308. The Policy Control Function (“PCF”) 314 includes the following functionality: supporting unified policy framework to govern network behavior, providing policy rales to control plane function(s) to enforce the policy rule, and implementing a front end to access subscription information relevant for policy decisions in the User Data Repository. The Network Exposure Function (“NEF”) 316 is deployed optionally for exchanging information with an external third party. In one embodiment, an Application Function (“AF”) 316 may store the application information in the Unified Data Repository via NEF. The UPF 310 communicates with the data network 318.

FIG. 4 shows another embodiment of a wireless network system for time synchronization. This architecture is merely one example and there may be more or fewer components for implementing the embodiments described herein. Two interconnections or communications between components are identified as N3 and N4, which may be referred to by other Figures. The other interconnections are not labeled. As shown, the N3 interface is between the base station (NG-RAN) and a user plane function (UPF) for user plane packet delivery. The components are described below.

A user equipment (UE) is accessing a wireless communication service (e.g. 5GS) and obtains services via a base station (NG-RAN) and interacts with an Access and Mobility Control Function (AMF) of the core network via the non-access stratum (NAS) signaling. FIG. 2 illustrates an example user equipment (“UE”) 104. The Device side TSN translator (DS-TT) is inside the UE, which provides the PTP port functionality for time synchronization. FIG. 1 illustrates an example base station or NG-RAN 102. The NG-RAN node may be responsible for the air interface resource scheduling and air interface connection management of the network to which the UE accesses. The AMF may include the following functionalities: Registration management, Connection management, Reachability management and Mobility Management. The AMF may also perform the access authentication and access authorization. The AMF may be the NAS security termination and relay the session management NAS between the UE and the SMF, etc.

The SMF may include the following functionalities: Session Management e.g. Session establishment, modify and release, UE IP address allocation & management (including optional Authorization), Selection and control of uplink function, downlink data notification, etc. The user plane function (“UPF”) may include the following functionalities: Anchor point for Intra-/Inter-RAT mobility. Packet routing & forwarding, Traffic usage reporting, Quality of Service (QoS) handling for user plane, downlink packet buffering and downlink data notification triggering, etc. The network side TSN Translator (NW-TT) is co-located with UPF, which provides the PTP port functionality for time synchronization and can interwork with the TSN network. A Policy Control Function (PCF) may include the following functionality: supporting a unified policy framework to govern network behavior, providing policy rules to Control Plane function(s) to enforce the policy rule, implementing a Front End to access subscription information relevant for policy decisions in a User Data Repository (UDR). A Network Exposure Function (NEF) is deployed optionally for exchanging information between a network (e.g. 5GS) and an external Application Function (AF). In one embodiment, an Application Function (“AF”) may store the application information in the Unified Data Repository via NEF. The UPF communicates with a data network. The NEF/AF are shown together in FIG. 4, though they may be separate is some embodiments.

Although not shown, there may be a Unified Data Management (“UDM”) that manages the subscription profile for the UEs. The subscription includes the data used for mobility management (e.g. restricted area), session management (e.g. QoS profile). The subscription data also includes slice selection parameters, which are used for AMF to select a proper SME. The AMF and SMF may get the subscription from the UDM. The subscription data may be stored in a Unified Data Repository with the UDM, which uses such data upon reception of request from AMF or SME.

The base station may also be referred to as a next generation radio access network (“NG-RAN”) node and can provide a time synchronization signal to user equipment (UE). The time synchronization signal may be through a System Information Block (SIB) or through a Radio Resource Control (RRC) message. The time synchronization signal may be referred to as “ReferenceTimeInfo.” In one embodiment, there may be at least two information elements (IE) in the ReferenceTimeInfo, including referenceSFN, which indicates the reference System Frame Number (SFN) corresponding to the reference time information, and also including the time (e.g. Reference Time). The Reference Time may be a time field that indicates the time at the SFN boundary.

FIG. 5 shows an embodiment of time synchronization with access stratum time distribution on demand. Rather than just constantly providing a time synchronization signal, the signal may be only provided on demand. This is a more efficient use of resources. Rather than just providing a time synchronization signal to every UE in range (even those that do not require it), FIG. 5 illustrates providing time synchronization on demand.

FIG. 5 illustrates user equipment (UE), a base station (NG-RAN), a Access & Mobility Management Function (AMF), a Policy Control Function (PCF), a Binding Support Function (BSF), a Time Sensitive Communication and Time Synchronization function (TSCTSF), and a Network Exposure Function (NEF) with an Application Function (AF). The NEF/AF are shown together in FIG. 5, though they may be separate is some embodiments. In block 501, the Access and Mobility (AM) policy association is established for the UE. In block 502, the NEF/AF invokes the Ntsctsf_ASTICreate/Update/Delete/Get service operation with the TSCTSF. In block 503, the TSCTSF searches the PCF for the UE using Nbsf_Management_Subscribe with a UE identification (UE ID), such as with a Subscription Permanent Identifier (SUPI) as an input parameter, indicating that it is searching for the PCF that handles the AM Policy Association of the UE. In block 504, the BSF provides to the TSCTSF the identity of the PCF for the UE for the requested SUPI via an Nbsf_Management_Notify operation. If matching entries were already present in the BSF when block 503 is performed, then this shall be immediately reported to the TSCTSF. In block 505, the TSCTSF sends to the PCF for the UE its request for the AM policy of the UE (identified by SUPI) using a Npcf_AMPolicyAuthorization request, containing the 5G access stratum time distribution indication. In block 506, the PCF may initiate an AM Policy Association Modification procedure for the UE to provide AMF the 5G access stratum time distribution parameters. In block 507, the AMF sends the 5G access stratum time distribution indication to the NG-RAN node using an N2 request. As described below, the mobility for time synchronization is improved such that during handover or connect to idle mode, the time synchronization is still used. In block 508, the NG-RAN node provides the network/5GS precise time to the UE via access stratum (AS).

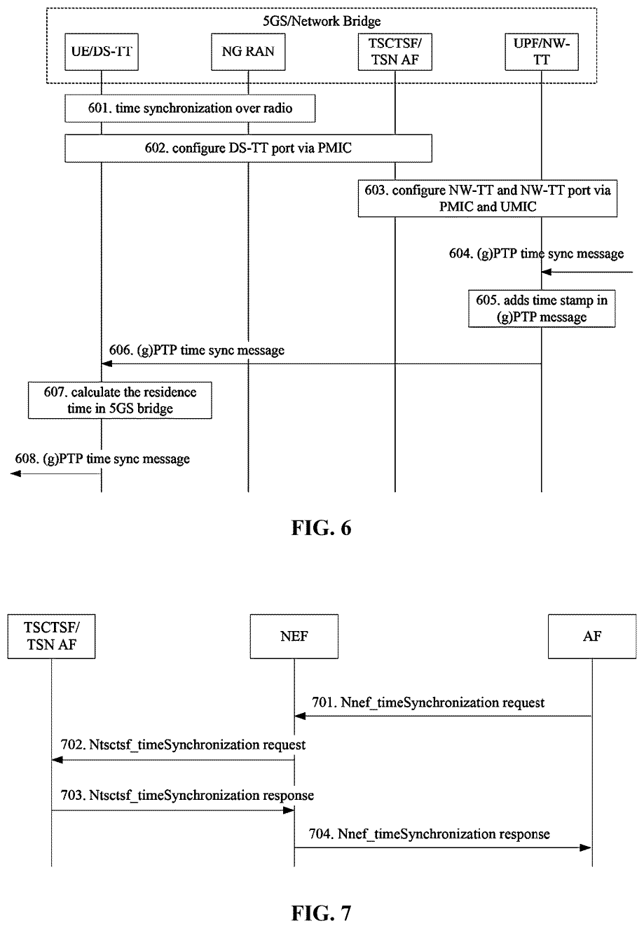

FIG. 6 shows an embodiment of time synchronization with Precision Time Protocol (PTP) in a network, such as 5GS. In one embodiment, there may be a 5GS/Network Bridge, which may include a TSN Bridge as shown in FIG. 4. There may be a device side TSN Translator (DS-TT) in the UE, and a Network TSN Translator (NW-TT) in the User Plane Function (UPF). The DS-TT and the NW-TT can work with the PTP network outside of a network/5GS (e.g TSN network, 1588 network, etc.). In the network, the NG-RAN and UPF may have time synchronized with a network internal Grand Master (GM) clock so that the base station/NG-RAN and UPF have the same precise time. This synchronized time can then be used to synchronize UEs from the base station/NG-RAN. In some embodiments, the UPF/NW-TT may have time synchronized from outside PTP network, such that the UPF has an internal time and external time simultaneously.

In block 601, the base station/NG-RAN node provides the network's precise time to the UE/DS-TT through access stratum (AS) as discussed above. At this point, the UPF, the NG-RAN and the UE have the same precise time, which means time is synchronized. In block 602, the TSCTSF/TSN AF reads or configures the PTP port in the UE/DS-TT using Port Management Information Container (PMIC) which is carried in the signaling for the UE PDU session. The signaling between the TSCTSF/TSN AF and the UE/DS-TT may be via PCF, SMF, AMF, and/or NG-RAN. In block 603, the TSCTSF/TSN AF reads or configures the PTP port in the UPF/NW-TT using PMIC and User-Plane Node Management Information Container (UMIC) which is carried in the signaling for the PDU session. The signaling between the TSCTSF/TSN AF and the UPF/NW-TT is via PCF or SMF.

In block 604, the UPF/NW-TT port receives a PTP message which may be from N6 (as shown in FIG. 3). The PTP message may include a (g)PTP message. In block 605, upon reception of a PTP event message from the upstream PTP instance the NW-TT makes an ingress timestamping (TSi) for the time from a PTP message. In block 606, the UPF/NW-TT adds TSi in the Suffix field of the PTP message and send to UB in user plane via PDU session. In block 607, the UE/DS-TT creates egress timestamping (TSe) for the (g)PTP messages. The difference between TSi and TSe is considered as the calculated residence time spent within the SOS/Network Bridge for this PTP message expressed in a network/5GS time, which may assume external and internal time speed are synced. In block 608, the UE/DS-TT converts the residence time spent within the network/5GS to the PTP domain time and modifies the payload of the PTP message that it sends towards the downstream PTP node.

When the UE/DS-TT receives the PTP message from a device in the uplink (UL) direction, the handling may be similar. The DS-TT may create the TSi and sends it to the UPF/NW-TT. The NW-IT creates the TSe and calculates the residence time. The UPF/NW-TT converts the residence time spent within the network/5GS to the PTP domain time and modifies the payload of the PTP message that it sends towards the downstream PTP node.

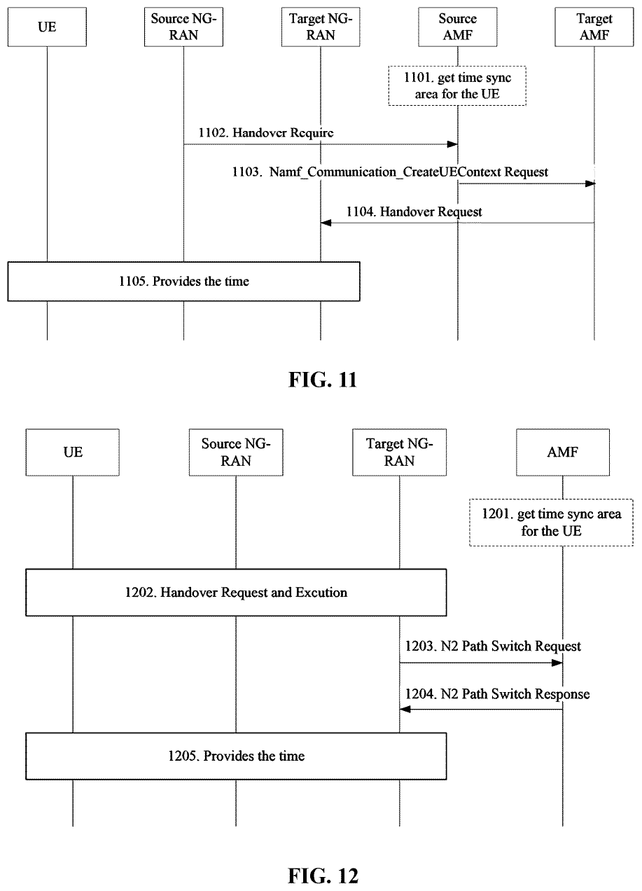

FIG. 6 illustrates a time synchronization that is alternate to the time synchronization from FIG. 5. FIG. 5 is an over the air or over the radio synchronization. While FIG. 5 is an on-demand time synchronization. However, when the time is provided via the network/5G AS signaling is on demand, there may be an issue when the UE has mobility and moves between base stations. The mobility issue is discussed with respect to FIGS. 11-13. The UE may be area restricted to only can obtain time synchronization service in particular area, such that when the UE moves out the time synchronization service area, the time synchronization service may be stopped for the UE. The area restriction for time synchronization is discussed with respect to FIGS. 7-10.

The area restriction of time synchronization is described with respect to FIGS. 7-10. The NEF/AF provides the time synchronization area of one or more UEs to the TSCTSF. The time synchronization area may include a cell list, a tracking area (TA), or a TA list. The UE(s) may be identified by a UE ID (e.g. SUPI, GPSI), or a UE address (e.g. IP address or MAC address).

For the 5G access stratum time distribution on demand (shown in FIG. 5), the TSCTSF (as the sender) send the time synchronization area to the AMF via the PCF. In one embodiment, the AMF may further send the synchronization area to the NG-RAN. In some embodiments, a subset of time synchronization area is received by the base station/NG-RAN from AMF. The NG-RAN provides precise time to UE when the UE is in the time synchronization area. In another embodiment, the AMF indicates whether the UB is inside or outside of the time synchronization area with the base station/NG-RAN. When the NG-RAN reports the notification of whether the UE is inside or outside the time synchronization area, the AMF can send an N2 request to start or stop the time synchronization to this UE. In the embodiment with the PTP time synchronization, the TSCTSF/TSN AF may provide whether the UE is inside or outside of the time synchronization area to the AME. The TSCTSF/TSN AF may provide to the AME directly or through the UDM or PCF. The TSCTSF/TSN AF may provide to the SME via PCF, and/or the SMF provides whether the UE is inside/outside the time synchronization area to the AMF. The AMF further provides this to the base station/NG-RAN. When the TSCTSF/TSN AF receives the notification of whether the UE is inside/outside the time synchronization area (i.e. an indication of the time synchronization area) The TSCTSF/TSN AF may configure the PTP port in the UE/DS-TT (i.e. enable, disable). When the UE is inside the time synchronization area, the TSCTSF enables the PTP port in the UB/DS-TT. When the UE is outside of time synchronization area, the TSCTSF disables the PTP port in the UE/DS-TT. The notification of whether the UE is inside/outside the time synchronization area may include an NG-RAN report to the AME, with the AMF reporting to the SMF. When the SME receives the report, it sends the notification to the PCF, which sends the notification to the TSCTSF, or the AMF notifies the TSCTSF/TSN AF directly.

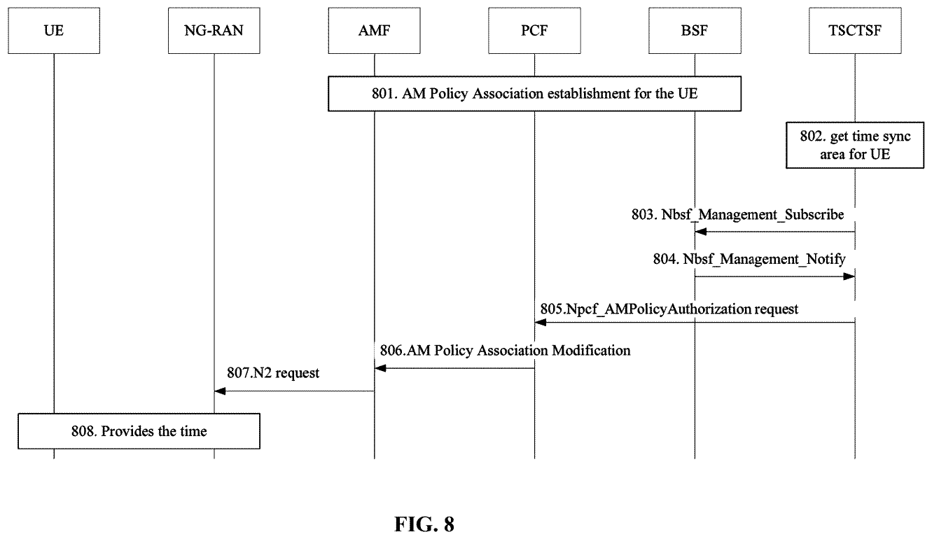

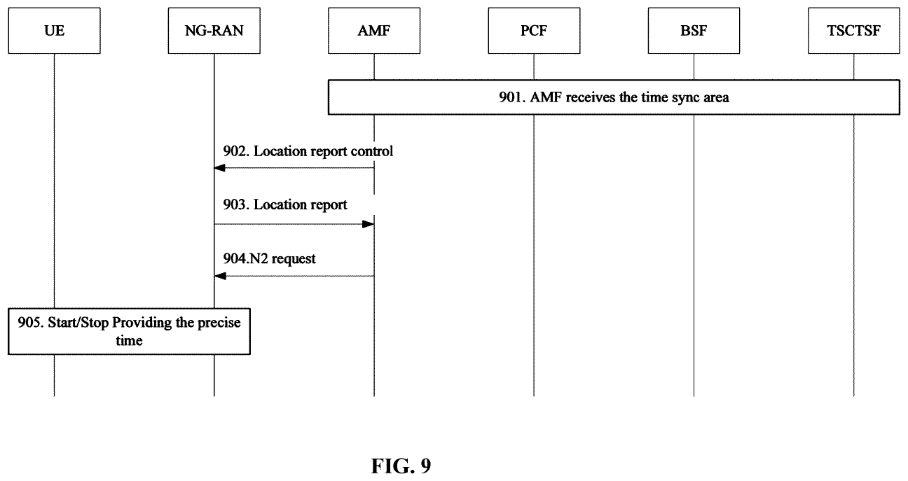

FIG. 7 shows an embodiment for providing a time synchronization area. The time synchronization area may be provided to the TSCTSF/TSN AF. FIG. 7 may be used by FIGS. 8-9, which are described below. In block 701, the AF creates a time synchronization service (which may also be referred to as a time synchronization signal/information/notification). In one embodiment, it may invoke Nnef_TimeSynchronization_ConfigCreate or Nnef_TimeSynchronization_ConfigUpdate service operation. The request may include the time synchronization area of one or more UEs. The time synchronization area may be geographical area information, a cell list, a tracking area (TA), or a TA list. The UE may be identified by a Generic Public Subscription Identifier (GPSI), a GPSI list, a Subscription Permanent Identifier (SUPI), a SUPI list, an external group ID, or a UE address, including a UE ID, MAC ID, or other identifier.

In block 702, if time synchronization area information (e.g. geographical area information) was provided by the AF, then the NEF translates the time synchronization area to a different format, such as a Cell ID, Cell ID list, TA, or TAI list format. If the external ID and GPSI is received from the AF, the NEF can map it to SUPI (as the UE ID). The NEF may invokes the Ntsctsf_TimeSynchronization_ConfigCreate or Ntsctsf_TimeSynchronization_ConfigCreate service operation with the parameters as received from the AF and translated time sync area for the UE(s) to TSCTSF. The NEF also may provide the translated time sync area for the UE(s) to TSN AF. In block 403, the TSCTSF/TSN AF responds to NEF and in block 404, the NEF responds to AF. In one embodiment, if the AF is in the trusted domain, it may provide the information to the TSCTSF/TSN AF directly, and the NEF is not needed in this embodiment.

FIG. 8 shows an embodiment of access stratum (AS) time provisioning with an area restriction. An area restriction is the limitation for determining whether a UE is within a geographic range for receiving a synchronization signal. The base stations should synchronize time for these UEs inside of the time synchronization area. This is referred to as on-demand time synchronization. The area restriction can improve the on-demand time synchronization shown in FIG. 5. FIG. 8 shows the how the UE is provided precise time in AS signaling (i.e. radio interface) in a particular area.

In block 801, the AM Policy Association for the UE is established. In block 802, the TSCTSF receives the time synchronization area for the UE (or for the UE list). In block 803, the TSCTSF searches the PCF for the UE using Nbsf_Management_Subscribe with a UE ID (i.e. SUPI or other identifier) as an input parameter. This indicates that it is searching for the PCF that handles the AM Policy Association of the UB. In block 804, the BSF provides to the TSCTSF the identity of the PCF for the UE for the requested SUPI via an Nbsf_Management_Notify operation. If matching entries already exist in the BSF when block 803 is performed, this may be immediately reported to the TSCTSF.

In block 805, the TSCTSF sends to the PCF for the UE its request for the AM policy of the UE (identified by SUPI or another identifier) using Npcf_AMPolicy Authorization request, containing the access stratum (AS) time distribution indication and time synchronization area information (e.g. Cell ID list, TA, or TA list). In block 806, the PCF may initiate an AM Policy Association Modification procedure for the UE to provide AMF the AS time distribution parameters including time synchronization area. In block 807, the AMF sends the AS time distribution indication and time synchronization area to a base station (NG-RAN node) using an N2 request. The time synchronization area in this message may be a subset of the received time synchronization area, which may only be related to this base station (NG-RAN node). In block 808, the base station (NG-RAN) provides the precise time to the UE via AS depending on whether the UE is in the time synchronization area.

FIG. 9 shows another embodiment of access stratum (AS) time provisioning with an area restriction controlled by Access and Mobility Management Function (AMF). The area restriction and AS time provisioning may be controlled by the AMF. The UB is provided precise time in AS signaling (radio interface) in a specified area (i.e. time synchronization area) controlled by the AMF.

In block 901, the AMF is provided with the time synchronization area, and the AM Policy Association for the UE is established. Block 901 may be comparable to FIG. 8. In block 902, the AMF sends Location Reporting Control (e.g. Reporting Type, Area of Interest, etc.) to the base station (NG-RAN). In block 903, the base station (NG-RAN) sends a Location Report message informing the AMP about the location of the UE including the UE Presence in the Area of Interest (i.e., Inside or Outside of the time synchronization area, or Unknown location). In block 904, depending on whether the UB is in the time synchronization area, the AMP send the AS time distribution indication to the base station/NG-RAN to stop or start the time synchronization operation. In block 905, depending on the message from the AMF, the base station/NG-RAN may start or stop providing the precise time to the UE.

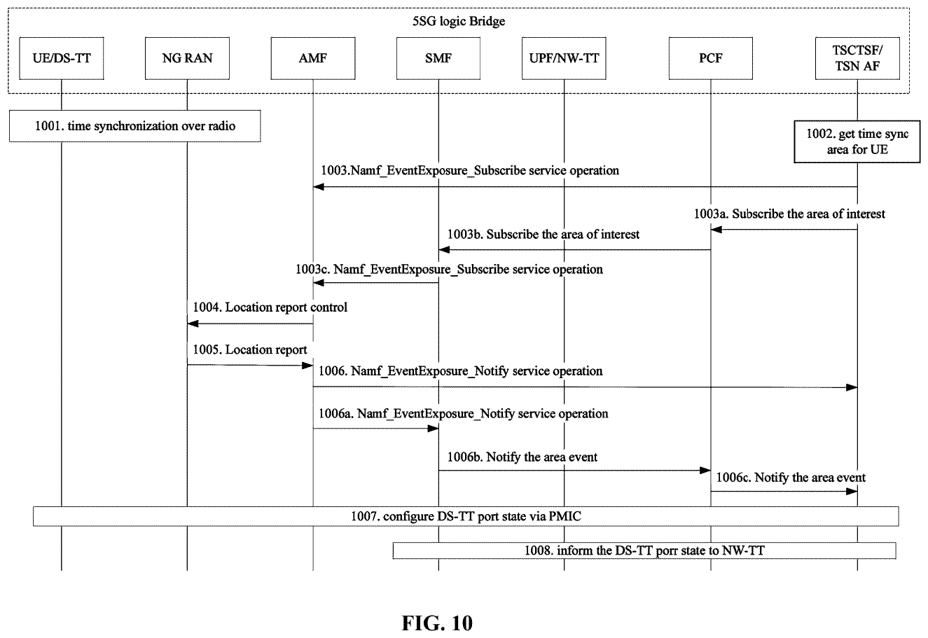

FIG. 10 shows an embodiment of time synchronization with Precision Time Protocol (PTP) and with an area restriction. FIG. 10 shows how the PTP based time synchronization may be restricted according to the UE location and whether the UE is in the time synchronization area. The pre-condition may be similar as in FIG. 6. In one embodiment, the PTP may be or may include generalized PTP (gPTP or (g)PTP). PTP and gPTP may be interchangeable for these embodiments.

In block 1001, the base station/NG-RAN node provides the precise time to the UB/DS-TT via AS. Then the UPF, base station/NG-RAN and UE should all have the same precise time, which means the time is synchronized. In block 1002, the TSCTSF/TSN AF receives the time synchronization area for the UB (or UE list) as in FIG. 7. The TSCTSF/TSN AF subscribes to the time synchronization area (which may also be referred to as the area of interest) to AMF. Subscribes may refer to the transmission of a notification or information. The subscription may include the TSCTSF/TSN AF subscribing with the AMF directly in block 1003, along with the AMF notifying in block 1006. In an alternative, the subscription may include the TSCTSF/TSN AF subscribing with the AMF via Policy and Charging Function (PCF) and the SMF in blocks 1003a, 1003b, and 1003c. In addition, a notification may also be sent in blocks 1003a, 1003b, and 1003c. In some embodiments, only block 1003 is performed, while in other embodiments blocks 1003a, 1003b, and 1003c will be performed instead.

In block 1003, the TSCTSF/TSN AF subscribes to the time synchronization area with the AMF by using Namf_EventExposure_Subscribe request. In this block, the TSCTSF/TSN AF may also subscribe with AMF via UDM or PCF. The TSCTSF/TSN AF may subscribe with UDM using Nudm_EventExposure_Subscribe request, and the UDM subscribes with AMF by using Namf_EventExposure_Subscribe request. In an alternative embodiment, the TSCTSF/TSN AF subscribes with the PCF using Npcf_AMPolicyAuthorization_Subscribe request, and the PCF subscribes with the AMF by using Namf_EventExposure_Subscribe request. In these requests, the time synchronization area (i.e. area of interest) may be included. In an alternative embodiment with blocks 1003a-1003c, block 1003a includes the TSCTSF/TSN AF subscribe to the time synchronization area with the PCF by using Npcf_PolicyAuthorization_Update of Npcf_PolicyAuthorization_Subscribe request. In block 1003b. the PCF subscribes to the time synchronization area with the SMF by using Npcf_SMPolicyControl_UpdateNotify request. In block 1003c, the SMF subscribes to the time synchronization area with the AMF by using Namf_EventExposure_Subscribe request.

In block 1004, the AMF sends Location Reporting Control (Reporting Type, Area of Interest, etc.) to the base station (NG-RAN). In block 1005, the base station sends a Location Report message informing the AMF about the location of the UE including the UE Presence in the time synchronization area (i.e., INSIDE, OUTSIDE, or UNKNOWN). If block 1003 is used, then the AMF notifies in block 1006, were the AMF notifies the TSCTSF/TSN AF of whether there is a UE Presence in the time synchronization area (I.e., INSIDE, OUTSIDE, or UNKNOWN). The AMF may notify the UDM or PCF, which may notify the TSCTAF/TSN AF. If blocks 1003a-1003c are used, the AMF notifies in block 1006a. 1006b, and 1006c. In block 1006a, the AMF notifies the SMF of whether there is a UE Presence in the time synchronization area (i.e., INSIDE, OUTSIDE, or UNKNOWN). In block 1006b, the SMF notifies the PCF of whether there is a UE Presence in the time synchronization area (i.e., INSIDE, OUTSIDE, or UNKNOWN) by invoking Npcf_SMPolicyControl_Update. In block 1006c, the PCF notifies the TSCTSF/TSN AF of whether there is a UE Presence in the time synchronization area (i.e., INSIDE, OUTSIDE, or UNKNOWN) by invoking Npcf_PolicyAuthorization_Notify.

In block 1007, depending on whether the UB is in the time synchronization area, the TSCTSF/TSN AF configures the PTP port in the UE/DS-TT using PMIC which may be carried in the signaling for the UB PDU session. When the UE is outside of the time synchronization area, the signaling between TSCTSF/TSN AF and UE/DS-TT is via PCF SMF, AMF and base station/NG-RAN. When the UE is inside the time synchronization area, the TSCTSF/TSN AF enables the PTP port in the UE/DS-TT. If the UE is outside of the time synchronization area, the TSCTSF/TSN AF disables the PTP port in the UE/DS-TT. In block 1008, the TSCTSF/TSN AF informs the UE/DS-TT PTP port state to the UPF/NW-TT using PMIC or UMIC which is carried in the signaling for the PDU session. The signaling between the TSCTSF/TSN AF and the UPF/NW-TT may be via the PCF and/or the SMF.

When the time is provided via the network/5G AS signaling is on demand, there may be an issue when the UE has mobility and moves between base stations. The mobility issue is discussed with respect to FIGS. 11-13. The target base station/NG-RAN receives the time synchronization request indication. In some embodiments, this may include the time synchronization area. The mobility may include a N2 handover or an Xn handover. The embodiments allow for time synchronization during mobility or more specifically during handovers. As described, a handover may be a UE transitioning from a source base station (NG-RAN) to a target base station (NG-RAN).

FIG. 11 shows an embodiment of access stratum (AS) time synchronization during & handover. Specifically, FIG. 11 illustrates keeping time synchronization during an N2 handover, and how the target base station/NG-RAN knows it shall provide the precise time to the UE in the N2 handover procedure. During an N2 handover procedure, the AMF provides a time synchronization request indication to the target base station/NG-RAN in the handover request. In some embodiments, the AMF also provides the time synchronization area.

In block 1101, the AMF may receive the time synchronization area for the UE if the UE is restricted to get precise time via AS. This may be optional in some embodiments and may be similar to block 806 in FIG. 8. In block 1102, the source base station/NG-RAN may determine that the UE needs to be handed over to the target base station/NG-RAN. It then sends a Handover Require Message to a source AME. In block 1103, if the inter-AMF handover is needed, the source AMF sends the Namf_Communication_CreateUEContext Request to the target AMF. In the request, the time synchronization indication and optional time synchronization area may be included. In block 1104, the target AMF sends the handover request to the target base station/NG-RAN. The time synchronization indication and optional time sync area may be included. The time synchronization area in this message may be a subset of the received time synchronization area, which may be limited to that which is related to the target base station/NG-RAN node. For the intra-AMF N2 handover (i.e. the source AMF and target AMF is the same), there may be no block 1103. In block 1105, after the handover procedure, the target base station/NG-RAN node provides the precise time to the UE via AS and may include the time synchronization area in some embodiments.

FIG. 12 shows another embodiment of access stratum (AS) time synchronization during a handover. FIG. 12 shows Xn handover from a source base station/NG-RAN to a target base station/NG-RAN. FIG. 12 shows how the target base station/NG-RAN knows it should provide the precise time to the UE during the Xn handover procedure. During the Xn handover procedure, the AMF provides the time synchronization request indication to the target base station/NG-RAN in the Path Switch Acknowledgement signal. In some embodiments, the AMF may also provide the time synchronization area. The source base station/NG-RAN may provide the time synchronization request indication to the target base station/NG-RAN in the handover request. The time synchronization area may also be provided in the path switch acknowledgment.

In block 1201, the AMF may receive the time synchronization area for the UE if the UE is restricted to get precise time via access stratum. This may be similar to block 806 in FIG. 8. In block 1202, the source base station/NG-RAN may initiate the handover preparation and execution with the target base station/NG-RAN. The source base station/NG-RAN may send the time synchronization indication to the target NG-RAN. In block 1203, the target base station/NG-RAN may send an N2 Path Switch Request to the AMF. In block 1204, the AMF sends the N2 Path Switch Request Acknowledgement to the target base station/NG-RAN. The time synchronization indication is included and, in some embodiments, the time synchronization area may also be included. If included, the time synchronization area in this message may be a subset of a received time synchronization area, where the subset is specific to the target base station/NG-RAN node. In block 1205, after the handover procedure, the target base station/NG-RAN node provides the precise time to the UE via AS. In some embodiments, the time synchronization area may be included here.

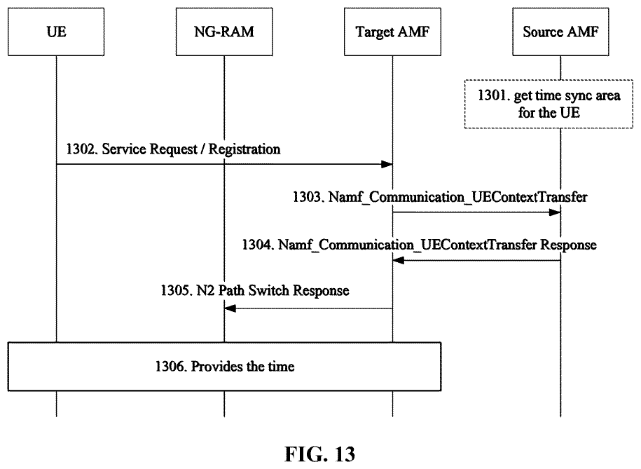

FIG. 13 shows an embodiment of access stratum (AS) time synchronization while user equipment (UE) is in idle to connect mode. FIG. 13 shows how the base station/NG-RAN knows when to provide the precise time to UE. The base station provides the precise time for time synchronization while the UE is from idle mode to connect mode. In one embodiment, when the UE is from idle to connect mode, the AMF provides the time synchronization request indication to the base station/NG-RAN. In some embodiments, the AMF may also provide the time synchronization area.

In block 1301, the AME may receive the time synchronization area for the UE if the UE is are restricted to get precise time via AS. This block may be optional and may be similar to block 806 in FIG. 8. In block 1302, the UE is in idle mode and is transferring to connect mode. The UE sends a Registration/Service Request message to the AME In block 1303, when the AMF receives the Registration message, it may be the target AME. It retrieves the DE context from the source AMF by invoking Namf_Communication_UEContextTransfer request. In block 1304, the source AMF responds to the target AMF with the UE context, including the AS time distribution indication and in some embodiments, may include the time synchronization area. If the UE sends the Service request, or there is no AMF change when the UE send the registration, then the source AMF and the target AMF are the same, in which case blocks 1303 and 1304 are not needed. In block 1305, the AMF sends an N2 request to the base station/NG-RAN. The time synchronization indication and in some embodiments, the time synchronization area are included. The time synchronization area in this message may be subset of received time synchronization area, such as the area that is only related to the target base station/NG-RAN node. In block 1306, the base station/NG-RAN node provides the precise time to the UE via AS. In some embodiments, this may be dependent on whether the UE is in the time synchronization area.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium.” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless communication, comprising:
receiving a time synchronization area that covers a location for a user equipment (UE); and
providing, based on the time synchronization area and the UE, a time to the DE for synchronization.

2. The method of claim 1, wherein the time synchronization area comprises a cell list, a tracking area (TA), or a TA list.

3. The method of claim 1, wherein the location comprises a service area in which the UE can receive a time synchronization signal, wherein the time synchronization signal is not provided to the UE when the UE is outside of the service area.

4. The method of claim 1, wherein a time sensitive control function receives information on whether the location is in the service area.

5. The method of claim 4, wherein the time sensitive control function comprises a Time Sensitive Communication Time Synchronization Function (TSCTSF) or a Time Sensitive Networking Adaptation Function (TSN AF).

6. The method of claim 4, wherein the TSCTSF or TSN AF enables a Precision Time Protocol (PTP) port in a Device Side Time Sensitive Networking (TSN) Translator (DS-TT) when the location is in the service area and disables the PTP port in the DS-TT when the location is outside the service area.

7. The method of claim 1, wherein the UE is identified for the location by a UE identification or a UE address.

8. The method of claim 1, wherein the receiving and the providing are by a base station, wherein an Access and Mobility Function (AMF) provides the time synchronization area to the base station.

9. The method of claim 8, further comprising:
determining when the UE is in the time synchronization area; and
providing, only when the UE is in the time synchronization area, a time to the UE for time synchronization for the UE.

10. The method of claim 1, wherein the receiving is by an AMF, which receives the time synchronization area that covers a location for a user equipment (UE), wherein the method further comprises:
sending an indication of whether time synchronization is provided to the UE from base station.

11. A method for wireless communication, comprising:
providing a time synchronization area; and
receiving a notification of whether a user equipment (UE) is within the time synchronization area.

12. The method of claim 11, wherein the time synchronization area comprises a cell list, a tracking area (TA), or a TA list.

13. The method of claim 11, wherein the time synchronization area comprises a service area in which the UE can receive the time synchronization signal, wherein the time synchronization signal is not provided to the UE when the UE is outside of the service area.

14. The method of claim 11, wherein the providing is from a Time Sensitive Communication Time Synchronization Function (TSCTSF) or a Time Sensitive Networking Adaptation Function (TSN AF) to a base station.

15. The method of claim 14, wherein the TSCTSF or the TSN AF enables a Precision Time Protocol (PTP) port in a Device Side Time Sensitive Networking (TSN) Translator (DS-TT) when the location is in the service area and disables the PTP port in the DS-TT when the UE location is outside the service area.

16. The method of claim 11, wherein the UE is identified for the time synchronization area by a UE identification or a UE address.

17. The method of claim 16, wherein the providing is to a base station, wherein the method is further comprising:
determining, by a base station, when the identified UE is in the time synchronization area; and
providing, from the base station to the UE, the time synchronization signal, wherein the time synchronization signal is only provided when the UE is in the time synchronization area.

18-27. (canceled)

28. A wireless communications apparatus comprising a processor and a memory, wherein the processor is configured to read code from the memory and implement the method recited in claim 1.

29. (canceled)

30. A system for wireless communication comprising:
a Time Sensitive Communication Time Synchronization Function (TSCTSF) for providing a time synchronization area; and
a base station communicating with the TSCTSF to receive the time synchronization area. wherein the base station provides a time synchronization signal to a user equipment (UE) when the UE is within the time synchronization area.

31-34. (canceled)

35. A wireless communications apparatus comprising a processor and a memory, wherein the processor is configured to read code from the memory and implement the method recited in claim 11.
